(19) United States
(12) Patent Application Publication
(10) Pub. No.: US 2015/0201119 A1
(43) Pub. Date: Jul. 16, 2015

(54) Camera with native AFDX interface

(71) Applicant: ORBIT COMMUNICATION SYSTEMS LTD., NETANYA (IL)

(72) Inventors: Ofer REICH, Kadima (IL); Uri GORIN, Ramat-Ishai (IL); Dror FRANCIS, Haifa (IL); Yaron FINEGOLD, Nofit (IL)

(21) Appl. No.: 14/595,229

(22) Filed: Jan. 13, 2015

Related U.S. Application Data
(60) Provisional application No. 61/926,432, filed on Jan. 13, 2014.

(51) Int. Cl. H04N 5/232; H04N 7/18

(52) U.S. Cl. CPC H04N 5/23206; H04N 7/183

(57) ABSTRACT

A native AFDX camera captures images and video under control, and in communication with, one or more AFDX networks. The system facilitates deployment of an image capture device on an AFDX network, including native (embedded) AFDX bi-directional ring support, eliminating the need for a separate legacy adapter, the accompanying additional wiring and interconnect complexity. Thus the complexity, weight, and power consumption is reduced, as compared to conventional camera deployments.

### CROSS-REFERENCE TO RELATED APPLICATIONS

This application claims the benefit of provisional patent application (PPA) Ser. No. 61/926,432, filed Jan. 13, 2014 by the present inventors, which is incorporated by reference.

### FIELD OF THE INVENTION

The present invention generally relates to image capture devices, and in particular, it concerns a camera with a native (built-in) AFDX interface.

### BACKGROUND OF THE INVENTION

Aircraft data networks (ADNs) include the specification of data networking standards for use in aircraft installations and implementations thereof. The standards provide a means to adapt commercial networking standards and products (typically referred to as “commercial off the shelf” or COTS) to an aircraft environment. ADNs typically require higher reliability and specific performance requirements, as compared to commercial networks.

The requirement for high reliability networks in aircraft installations, that is higher reliability as compared to general commercial networks, is well known in the field. Discussion of high reliability ADNs can be found in publications such as publications of Aeronautical Radio Incorporated (ARINC), such as the ARINC 429, ARINC 629, ARINC Specification 664 Part 7, and IEEE 802.3 standards. A popular implementation of ARINC Specification 664 Part 7 is Avionics Full-Duplex Switched Ethernet (AFDX™, a trademark of AirBus).

Current ADNs include the use of multiple redundant devices, wiring, and complex networking protocols increasing the cost, weight, and complexity of current ADNs.

Refer to FIG. 1, a diagram of conventional deployment of a camera for use with an AFDX network. A conventional camera 100 includes commercially available interfaces for receiving command and control instructions, as well as output interfaces for outputting data such as captured images and video. In order to use a conventional camera 100 with an AFDX network 104, a legacy adapter 102 is required. The legacy adapter 102 converts instructions from the AFDX network 104 to instructions compatible for receiving via the legacy commercial receiving interface, and converts data output from the legacy commercial output interface to data compatible for communication on the AFDX network 104.

The use of legacy adapters adds additional wiring, interconnect complexity, weight, and power consumption to the deployment of cameras for use on AFDX networks.

### SUMMARY

The present invention provides an innovative camera including native (embedded) AFDX, including bi-directional ring support.

According to the teachings of the present embodiment there is provided an apparatus including:

(a) an image capture module;

(b) a processor operationally connected to the image capture module and configured to generate AFDX network compatible data based on output of the image capture module; and

(c) an AFDX interface (IF) module configured to transmit the AFDX network compatible data.

In an optional embodiment, the processor includes an AFDX frame encoder module to generate the AFDX network compatible data, based on the output of the image capture module. In another optional embodiment, the AFDX IF module is further configured to transmit directly to at least one AFDX network. In another optional embodiment, the at least one AFDX network is an AFDX bi-directional ring. In another optional embodiment, the AFDX IF module is further configured to receive instructions directly from an AFDX network. In another optional embodiment, the AFDX IF module is further configured to receive from at least one AFDX network. In another optional embodiment, the processor includes an AFDX frame decoder module to generate commands for the image capture module based on instructions received via the AFDX IF module. In another optional embodiment, the processor is further configured to configure the image capture module based on information received via the AFDX IF.

In an optional embodiment, the apparatus further includes a non-volatile memory module. In another optional embodiment, the non-volatile memory module is configured with AFDX configuration data for configuring the apparatus to operate with at least one AFDX network.

In another optional embodiment, the apparatus further includes a volatile memory module. In another optional embodiment, the volatile memory module is configured to store information from a group consisting of:

(a) the data from the image capture module;

(b) the instructions directly from an AFDX network; and

(c) computer-readable code.

### BRIEF DESCRIPTION OF FIGURES

The embodiment is herein described, by way of example only, with reference to the accompanying drawings, wherein:

FIG. 1, a diagram of conventional deployment of a camera for use with an AFDX network.

FIG. 2A, a diagram of an AFDX camera system.

FIG. 2B is an alternative view of a high-level partial block diagram of an exemplary system configured to implement AFDX camera.

FIG. 3, a simplified diagram of single ring connection.

FIG. 4, a simplified diagram of multiple (three) rings connection.

FIG. 5, a simplified diagram of multiple (three) rings connection with (two) shared ports.

FIG. 6, a simplified diagram of multiple (three) rings connection with one shared port.

FIG. 7, a simplified diagram of use of a configuration manager.

FIG. 8, a simplified diagram of single ring connection with one port.

### DETAILED DESCRIPTION

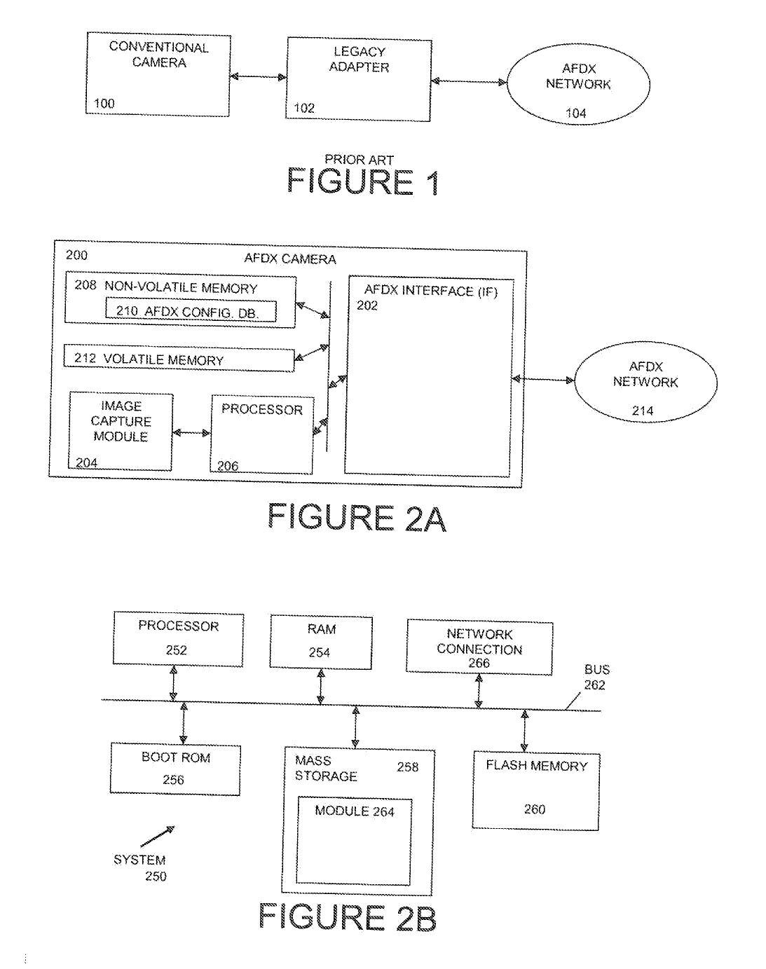

### FIGS. 1 TO 8

The principles and operation of the system according to a present embodiment may be better understood with reference to the drawings and the accompanying description. A present invention is a system for capturing images under control and in communication with, an AFDX network. The system facilitates deployment of an image capture device on an AFDX network, including native (embedded) AFDX bi-directional ring support, eliminating, the need for a separate legacy adapter, the accompanying additional wiring and interconnect complexity. Thus the complexity, weight, and power consumption is reduced, as compared to conventional camera deployments.

In the context of this description, the term “camera” is used for simplicity to refer to an image capture device, including, but not limited to still images and video images. The output of the camera is generally referred to as “data”. Similarly, the input to the camera is referred to as “instructions”, including, but not limited to command and control information. In the context of this document, AFDX ports are simply referred to as “ports” and referred to using the notation Pn, where “n” is an integer (typically n=1 or n=2 resulting in port pairs P1 and P2). A preferred embodiment is deployment with an AFDX network. AFDX is a specific implementation of ARINC Specification 664 Part 7, as currently used by Airbus and Boeing. The use of simplified terminology for clarity should not be interpreted as limiting the scope of the invention.

Based on this description, one skilled in the art will be able to use commercially available image capture modules and/or camera modules with accompanying interface documentation, along with the AFDX network specification to implement appropriate software, firmware, and hardware modules of the current invention.

Referring now to the drawings, FIG. 2A, a diagram of an AFDX camera system 200. The AFDX camera 200 includes an image capture module 204, a processor 206 operationally connected to the image capture module 204 and configured to generate AFDX network compatible data based on output of the image capture module 204, and an AFDX interface (IF) module 202 configured to transmit the AFDX network compatible data.

The processor 206 is generally a processing system of one or more processors. The processor 206 typically includes an AFDX frame encoder module (not shown) to generate the AFDX network compatible data based on the output of the image capture module.

A feature of the current embodiment is that the AFDX IF module 202 is configured to transmit directly to at least one AFDX network 214. In other words, the AFDX camera 200 is directly connected to at least one AFDX network 214, without the need for additional equipment (such as legacy adapter 102). The AFDX IF module 202 can provide 1-to-1 (one AFDX camera 200 to one AFDX network 311) and 1-to-N (one AFDX camera 200 to multiple AFDX networks [411 412, 413, etc.]), typically via multiple AFDX ports. At least one of the AFDX networks 104 can be an AFDX bi-directional ring. The AFDX IF module 202 can be implemented in a variety of formats, depending on the specific requirements of the planned deployment of the AFDX camera 200. Formats include, but are not limited to FPGA (field programmable gate arrays) and ASIC (application specific integrated circuits).

The AFDX camera 200 is preferably additionally configured to receive instructions directly from at least one AFDX network 104. Specifically, the AFDX IF module 202 is further configured to receive instructions directly from at least one AFDX network 104. The processor 206 can include an AFDX frame decoder module (not shown) to generate commands for the image capture module 204 based on instructions received via the AFDX IF module 202.

The processor 206 is further configured to configure the image capture module based on information received via the AFDX IF 202.

The AFDX camera 200 typically includes a non-volatile memory module 208. The non-volatile memory module 208 can include AFDX configuration data for example using an AFDX configuration database 210) for configuring the apparatus to operate with at least on AFDX network. The non-volatile memory module 208 can include other information as appropriate, for example computer-readable code (software).

The AFDX camera 200 typically includes a volatile memory module. The volatile memory module is configured to store information including, but not limited to the data from the image capture module, the instructions directly from an AFDX network, and computer-readable code.

FIG. 2B is an alternative view of a high-level partial block diagram of an exemplary system 250 configured to implement AFDX camera 200 of the present invention. System (processing system) 250 includes a processor 252 (one or more) and four exemplary memory devices: a RAM 254, a boot ROM 256, a mass storage device (hard disk) 258, and a flash memory 260, all communicating via a common bus 262. As is known in the art, processing and memory can include any computer readable medium storing software and/or firmware and/or any hardware element(s) including but not limited to field programmable logic array (FPLA) element(s), hard-wired logic element(s), field programmable gate array (FPGA) element(s), and application-specific integrated circuit (ASIC) element(s). Any instruction set architecture may be used in processor 252 including but not limited to reduced instruction set computer (RISC) architecture and/or complex instruction set computer (CISC) architecture. A module (processing module) 264 is shown on mass storage 258, but as will be obvious to one skilled in the art, could be located on any of The memory devices.

Mass storage device 258 is a non-limiting example of a non-transitory computer-readable storage medium bearing computer-readable code for implementing the AFDX camera functionality described herein. Other examples of such computer-readable storage media include read-only memories such as CDs bearing such code.

System 250 may have an operating system stored on the memory devices, the ROM may include boot code for the system, and the processor may be configured for executing the boot code to load the operating, system to RAM 254, executing the operating system to copy computer-readable code to RAM 254 and execute the code.

Network connection 266 provides communications to and from system 250. Typically, a single network connection provides one or more links, including virtual connections, to other devices on local and/or remote networks. Alternatively, system 250 can include more than one network connection (not shown), each network connection providing one or more links to other devices and/or networks.

System 250 can be implemented as a server or client respectively connected through a network to a client or server.

The processor 252 can implement the functionality described in reference to the processor 206. Similarly, the RAM 254 can implement the volatile memory 212, the boot ROM 256, the mass storage device. 258, or the flash memory 260 can implement the non-volatile memory 208, the network connection 266 can implement AFDX IF 202, and all of the modules can be operationally connected via bus 262.

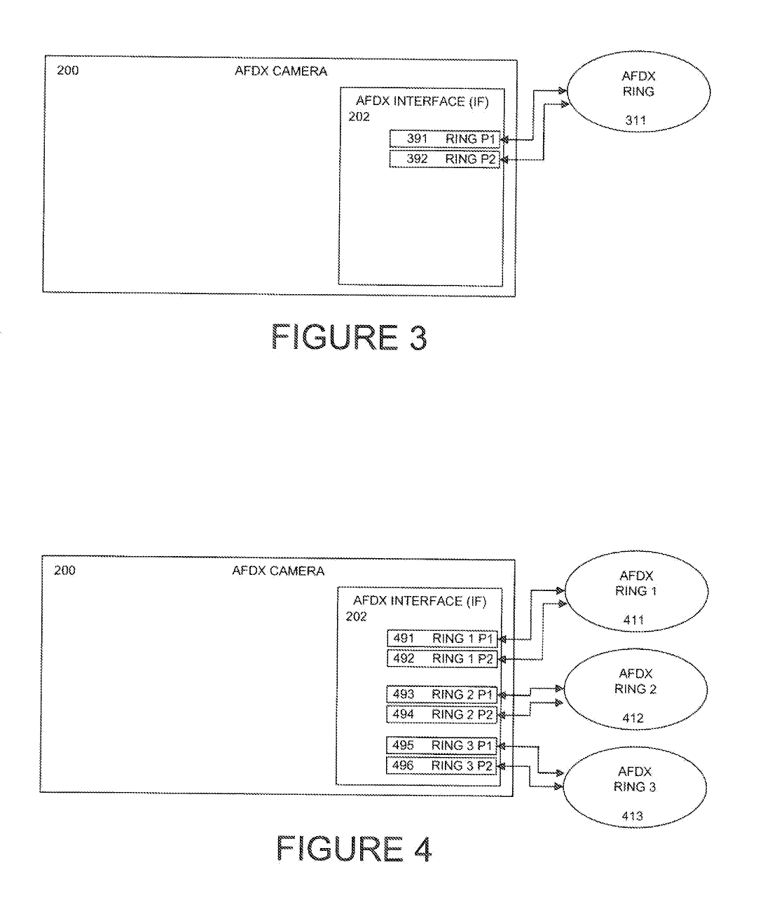

As described above, the AFDX camera 200 can be directly connected to at least one AFDX network 214, typically via multiple AFDX ports. In particular, as the preferred configuration of the AFDX networks are as rings with bi-directional communications, two AFDX ports on the AFDX IF 202 arc allocated to each ring. Ports can also be shared between rings. Typically, two ports (P1 and P2) ate allocated to each bi-directional ring. Both P1 and P2 send and receive data on the same ring. A difference between P1 and P2 is the direction of transmission. Data sent via P1 will travel through the ring in one direction and received via P2. Data sent via P2 will travel through the ring in another (counter) direction and be received via P1. For simplicity in FIG. 3 to FIG. 7, some elements of AFDX camera 200 are not shown.

Refer now to FIG. 3, a simplified diagram of single ring connection. In this case, the AFDX IF 202 has two ports: RING P1 391 and RING P2 392. Each of the two ports is connected to the AFDX ring 311.

Refer now to FIG. 4, a simplified diagram of multiple (three) rings connection. In this case, the AFDX IF 202 has the sets of ports, with each set having two ports, for a total of six ports. Each set of ports is allocated to one of the rings. RING 1 P1 491 and RING 1 P2 492 are allocated to AFDX ring 1 411. Similarly, RING 2 P1 493 and RING 2 P2 494 are allocated to AFDX ring 2 412 and RING 3 P1 495 and RING 3 P2 496 are allocated to AFDX ring 3 413.

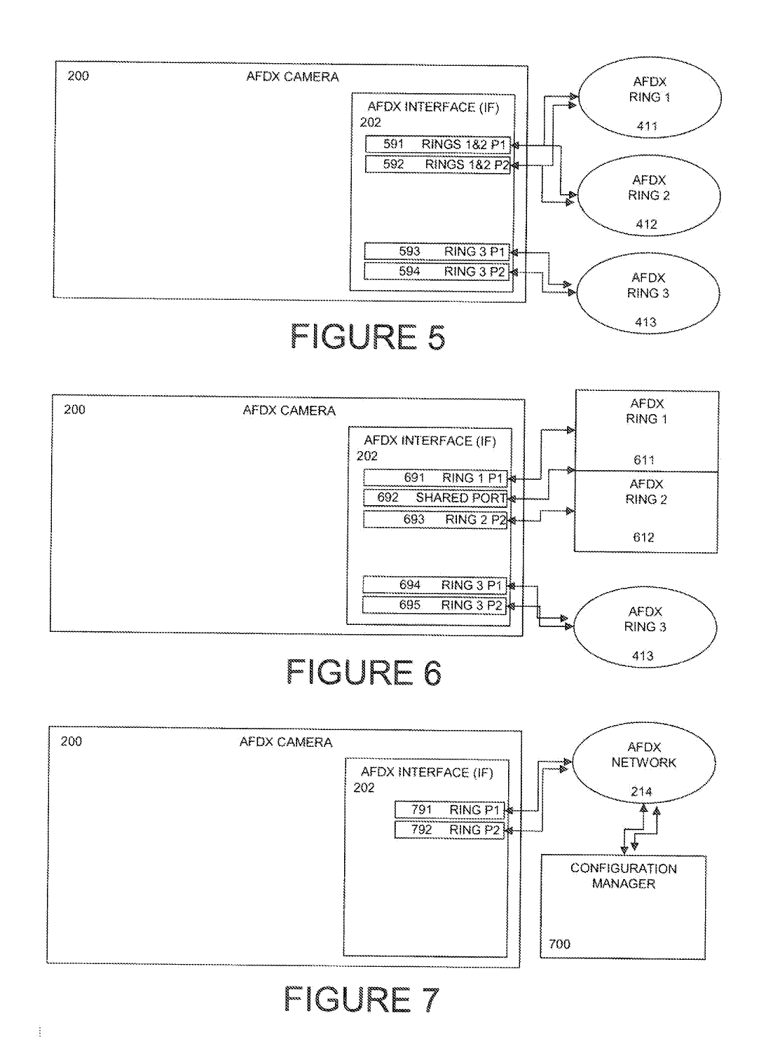

Refer now to FIG. 5, a simplified diagram of multiple (three) rings connection with (two) shared ports. In this case, the AFDX IF 202 has two sets of ports. The first set of ports includes two ports, RINGS 1&2 P1 591 and RINGS 1&2 P2 592, each port allocated to both. AFDX ring 1 411 and AFDX ring 2 412. A second set of ports includes RING 3 P1 593 and RING 3 P2 594 allocated to AFDX ring 3 413.

Refer now to FIG. 6, a simplified diagram of multiple (three) rings connection with one shared port. In this case, the AFDX IF 202 has two sets of ports. The first set of ports includes three ports, RING 1 P1 591 allocated to AFDX ring 1 611, SHARED PORT 692 allocated to both AFDX ring 1 611 and AFDX ring 2 612, and RING 2 P2 693 allocated to AFDX ring 2 612. A second set of ports includes RING 3 P1 694 and RING 3 P2 695 both allocated to AFDX ring 3 413.

Refer now to FIG. 7, a simplified diagram of use of a configuration manager 700. A configuration manager 700 can be operationally connected to at least one AFDX network 214. In this case, AFDX network 214 is connected to the AFDX camera via ports RING P1 791 (similar to RING P1 391) and RING P2 792 (similar to RING P2 392).

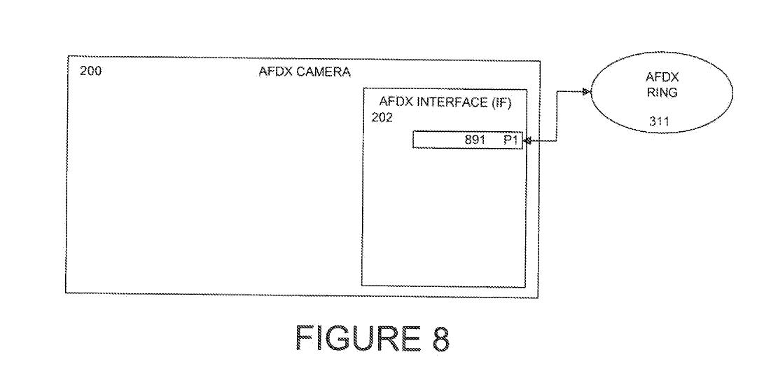

Refer now to FIG. 8, a simplified diagram of single ring connection with one port. In this case, the AFDX IF 202 has one port P1 891 allocated to AFDX ring 311.

Based on this description, one skilled in the art will be able to implement additional and alternative embodiments of the AFDX IF 202 to meet the requirements of specific applications. For example, an AFDX IF may have multiple sets of ports, with each port being re-configurable for use and/or enablement. In this non-limiting example, an AFDX IF could have eight ports, two of which are activated for use with a single ring.

In general, operation of the AFDX camera 200 with at least one AFDX network 214 features that data initiated by the AFDX camera 200 is sent in parallel to both ports (P1 and P2) of each ring. Instructions from P1 or from P2 of any ring targeted for the AFDX camera 200 is received by the AFDX IF 202, and via the processor 206 to the appropriate element of the camera, for example, the image capture module 204. Information from one of the rings of the AFDX ring (for example, P1) which was not initiated by the camera, and which is not targeted only for the camera, is passed through to another ring (for example, P2) of the related ring (per configuration). Similarly, in the current example, information from P2 which was not initiated by the camera, and which is not targeted only for the camera, is passed through to P1 of the related ring (per configuration).

The AFDX camera 200 can be configured via the AFDX network 214, in particular configuration of the image capture module 204 and AFDX parameters (for example, updating the AFDX configuration database 210 to change the AFDX operation or network parameters of the AFDX camera 200). Connections for configuration include, but are not limited to:

by AFDX connection via any of the AFDX ports,

by AFDX connection over any of the AFDX rings, and

by other interface and/or protocol other than AFDX.

As described above, information received by the AFDX IF 202, can be used by the processor 206 to configure the image capture module 204 or AFDX parameters (AFDX configuration database 210). Information can be received from the configuration manager 700 via any of the above listed connections. Similarly, the processor 206 can retrieve configuration information from the image capture module 204 or AFDX parameters (AFDX configuration database 210), and send the configuration information to the configuration manager 700 via any of the above listed connections.

Information for the image capture module 204 includes, but is not limited to:

Light sensitivity

Black White/Color

Illumination

Zoom

AFDX network configuration data includes but is not limited to data such as AFDX basic parameters:

Virtual links

BAG (Bandwidth Allocation Gap)

Latency

Frame size

Jitter

Mac address

Note that a variety of implementations for modules and processing are possible, depending on the application. Modules are preferably implemented in software, but can also be implemented in hardware and firmware, on a single processor or distributed processors, at one or more locations. The above-described module functions can be combined and implemented as fewer modules or separated into sub-functions and implemented as a larger number of modules, Based on the above description, one skilled in the art will be able to design an implementation for a specific application.

Note that the above-described examples, numbers used, and exemplary calculations are to assist in the description of this embodiment. Inadvertent typographical errors, mathematical errors, and/or the use of simplified calculations do not detract from the utility and basic advantages of the invention.

To the extent that the appended claims have been drafted without multiple dependencies, this has been done only to accommodate formal requirements in jurisdictions that do not allow such multiple dependencies. Note that all possible combinations of features that would be implied by rendering, the claims multiply dependent are explicitly envisaged and should be considered part of the invention.

It will be appreciated that the above descriptions are intended only to serve as examples, and that many other embodiments are possible within the scope of the present invention as defined in the appended claims.

What is claimed is:

1. An apparatus comprising:
(a) an image capture module;
(b) a processor operationally connected to said image capture module and configured to generate AFDX network compatible data based on output of said image capture module; and
(c) an AFDX interface (IF) module configured to transmit said AFDX network compatible data.

2. The apparatus of claim 1 wherein said processor includes an AFDX frame encoder module to generate said AFDX network compatible data, based on said output of said image capture module.

3. The apparatus of claim 1 wherein said AFDX IF module is further configured to transmit directly to at least one AFDX network.

4. The apparatus of claim 1 wherein said at least one AFDX network is an AFDX bi-directional ring.

5. The apparatus of claim 1 wherein said AFDX IF module is further configured to receive instructions directly from an AFDX network.

6. The apparatus of claim 1 wherein said AFDX IF module is further configured to receive from at least one AFDX network.

7. The apparatus of claim 1 wherein said processor includes an AFDX frame decoder module to generate commands for said image capture module haled on instructions received via said AFDX IF module.

8. The apparatus of claim 1 wherein said processor is further configured to configure said image capture module based on information received via said AFDX IF.

9. The apparatus of claim 1 wherein said apparatus further includes a non-volatile memory module.

10. The apparatus of claim 9 wherein said non-volatile memory module is configured with AFDX configuration data for configuring the apparatus to operate with at least one AFDX network.

11. The apparatus of claim 1 further including a volatile memory module.

12. The apparatus of claim 11 wherein said volatile memory module is configured to store information from a group consisting of:
(a) said data from said image capture module;
(b) said instructions directly from an AFDX network; and
(c) computer-readable code.
